(19) United States
(12) Patent Application Publication
(10) Pub. No.: US 2016/0110246 A1
(43) Pub. Date: Apr. 21, 2016

(54) DISK DATA MANAGEMENT

(71) Applicant: EMC Corporation, Hopkinton, MA (US)

(72) Inventors: Man Lv, Beijing (CN); Colin Yong Zou, Beijing (CN); Chris Zirui Liu, Beijing (CN); Xuan Liu, Beijing (CN); James Fei Wu, Beijing (CN)

(21) Appl. No.: 14/883,112

(22) Filed: Oct. 14, 2015

(30) Foreign Application Priority Data
Oct. 20, 2014 (CN) CN201410562531.X

(51) Int. Cl. G06F 11/07

(52) U.S. Cl. CPC G06F 11/0793; G06F 11/073; G06F 11/0751

(57) ABSTRACT

Embodiments of the present invention provide a method, a computer program product and apparatus for disk data management, that includes comprises obtaining BMS data from a disk, determining a bad sector in the disk based on the BMS data, and recovering data stored in the determined bad sector.

### RELATED APPLICATION

This application claims priority from Chinese Patent Application Number CN201410562531.X filed on Oct. 20, 2014 entitled “METHOD AND APPARATUS FOR DISK DATA MANAGEMENT” the content and teachings of which is herein incorporated by reference in its entirety.

### FIELD

Embodiments of the present disclosure relate to the field of data storage.

### BACKGROUND

Data integrity is an area of concern for most data storage systems. Typically, in data storage systems, bad sectors may be formed as data stored in sectors of a disk may not be accessed for a long time or may not be accessed for other reasons. Generally, disk scrubbing techniques may be designed to prevent bad sectors on the disk of the data storage systems, and further to recover data in the bad sectors before the data may be actually accessed. Conventional disk scrubbing techniques include: reading data sequentially from a disk; checking correctness of the data read; if the data read is incorrect or the data cannot be read from a sector of the disk, then data may be recovered. In a data storage system having a plurality of disks, this procedure may need to be executed for each disk.

These conventional disk scrubbing techniques have several disadvantages such as consumption of system resources, time cost problems, scrubbing accuracy, wear and tear of the disk.

### SUMMARY

Embodiments of the present disclosure provide a method, a computer program product and an apparatus for disk data management, which ameliorate several of the disadvantages.

According to an embodiment of the present disclosure, there is provided a method, a computer program product and an apparatus for disk data management, which comprises obtaining BMS (Background Medium Scan) data from a disk, determining a bad sector in the disk based on the BMS data, and recovering data stored in the determined bad sector.

### BRIEF DESCRIPTION OF THE SEVERAL VIEWS OF THE DRAWINGS

Through the more detailed description of example embodiments of the present disclosure in the accompanying drawings, the above and other objects, features, and advantages of the present disclosure will become more apparent, wherein the same references generally refer to the same components in the example embodiments of the present disclosure.

FIG. 1 illustrates a block diagram of an example computer system/server suitable for implementing embodiments of the present disclosure ;

FIG. 2 illustrates a flowchart of a method for disk data management according to an embodiment of the present disclosure;

FIG. 3 illustrates a schematic diagram of an example BMS status page format according to an embodiment of the present disclosure;

FIG. 4 illustrates a schematic diagram of an example BMS result page format according to an embodiment of the present disclosure; and

FIG. 5 illustrates a block diagram of an apparatus for disk data management according to one embodiment of the present disclosure.

### DETAILED DESCRIPTION

Some preferred embodiments will be described in more details below with reference to the accompanying drawings, in which the preferred embodiments of the present disclosure have been illustrated. However, it should be appreciated that the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

Some embodiment of conventional disk scrubbing techniques may suffer from several disadvantages, wherein a few include:

(1) A problem of consumption of system resources. In one embodiment, as data may need to be read and checked from the disk, the disk scrubbing procedure may cause large consumption of system resources. In an example embodiment, a large portion of I/O (input/output) resources, memory resources, CPU (central processing unit) resources may be occupied during disk scrubbing, which may affect normal I/O read operations and a system processing speed.
(2) A time cost problem. In one embodiment, read operations of the disk take may consume a large amount of time. In a further embodiment, since the data storage system may tend to have larger capacity, for example, 4TB or bigger, completion of the disk scrubbing may consume more time. In a further embodiment, in case where the data storage system may have a plurality of disks, due to limitations of I/O resources, the plurality of disks ay need to be read and data may need to be checked in sequence, which may further increases the processing time.
(3) A problem of accuracy of scrubbing results. In one embodiment, during disk scrubbing, connections of the I/O ports may affect the scrubbing results since the disk read operations may be involved. In an example embodiment, a failure of an I/O port may result in that the disk scrubbing procedure may not be able to determine whether the data to be read through this I/O port need to be recovered.
(4) The wear of the disk. In one embodiment, reading data from the disk for the disk scrubbing may also result in wear on the disk. There may be several other disadvantages that are not included herein.

Embodiments of the present disclosure provide a method, a computer program product and a system to ameliorate these disadvantages. According to an embodiment of the present disclosure, there is provided a method, a computer program product and an apparatus for disk data management. In a further embodiment, BMS (Background Medium Scan) data from a disk may be obtained. In a further embodiment, a bad sector in a disk based on a BMS data may be determined. In yet a further embodiment, data stored in a determined bad sector may be recovered. In a further embodiment, BMS data may be recorded according to execution of BMS by a disk.

In one embodiment, before a disk executes a BMS, a parameter for the BMS may be configured. In a further embodiment, a parameter may include at least one of minimum idle time before an execution of a BMS and BMS interval time.

In one embodiment, BMS data may include BMS status information and BMS result entries. In one embodiment, determining a bad sector in a disk based on a BMS data may include determining time duration of last execution of a BMS based on a BMS status information. In a further embodiment, based on a time duration of a last execution of a BMS, from a BMS result entries, BMS result entries recorded according to a last execution of the BMS may be identified. And in a further embodiment, a bad sector in a disk based on an identified BMS result entries may be determined

In one embodiment, each of the BMS result entries may include at least from a group consisting of: an error type, time of error occurrence, a position, and a recovery status of a sector. In a further embodiment error type may include at least a recovered error and a medium error. In one embodiment, a bad sector in a disk based on an identified BMS result entries may include determining a first result entry from an identified BMS result entries. In a further embodiment, a first result entry may include an error type indicating a medium error and a recovery status indicating that the sector is not corrected. And in a further embodiment, a bad sector of the disk based on a position included in a first result entry may be determined.

In one embodiment, a BMS status information from the disk may be queried, before obtaining the BMS data, to determine whether the execution of the BMS may be completed. In one embodiment, data stored in a determined bad sector may be recovered. In a further embodiment, data stored in a determined bad sector may be recovered. And in a further embodiment, a determined bad sector may be reallocated in another available sector of a disk based on RAID redundancy. In one embodiment, an indication related to a health condition of a disk may be generated based on BMS result entries recorded according to at least one execution of the BMS.

In one embodiment there is provided an apparatus for disk data management. In a further embodiment, the apparatus may have an obtaining unit that may be configured to obtain BMS data from a disk. In a further embodiment, the apparatus may also have a determining unit that may be configured to determine a bad sector in a disk based on BMS data. In a further embodiment, the apparatus may have a recovering unit that may be configured to recover data stored in a determined bad sector. In a further embodiment, BMS data may be recorded according to execution of BMS by the disk.

In a further embodiment, the apparatus may have a configuring unit that may be configured to configure, before a disk executes BMS, a parameter for the BMS. In a further embodiment, parameter may have at least one of minimum idle time before an execution of BMS and BMS interval time. In a further embodiment, BMS data may include BMS status information and BMS result entries. In a further embodiment, the determining unit may further include an execution time determining unit that may be configured to determine time duration of last execution of BMS based on BMS status information. In a further embodiment, the determining unit may further include a result entry identifying unit that may be configured to identify, based on a time duration of a last execution of BMS, from BMS result entries, BMS result entries that may have been recorded according to the last execution of BMS. In a further embodiment, determining unit may be configured to determine a bad sector in a disk based on identified BMS result entries.

In one embodiment, each of the BMS result entries may include at least an error type, time of error occurrence, a position, and a recovery status of a sector in a further embodiment, an error type may at least include a recovered error and a medium error. In a further embodiment, the determining unit may be further configured to determine a first result entry from identified BMS result entries. In a further embodiment, a first result entry may include an error type indicating a medium error and a recovery status that may indicate that a sector is not corrected. In a further embodiment, bad sector in the disk y be determined based on a position included in a first result entry.

In one embodiment, the apparatus may include a query unit that may be configured to query for BMS status information from a disk, before obtaining BMS data, to determine whether an execution of the BMS may have been completed. In one embodiment, recovering unit may be further configured to recover the data stored in a determined bad sector and may be configured to relocate a determined bad sector in another available sector of a disk based on RAID redundancy.

In one embodiment, the apparatus may further include an indication generating unit that may be configured to generate an indication related to a health condition of the disk based on BMS result entries recorded according to at least one execution of BMS.

It will be appreciated through the description below that according to embodiments of the present disclosure; BMS capability of a disk may be utilized to implement disk scrubbing. In a further embodiment, a bad sector of a disk may be determined and data stored in the bad sector may be recovered by obtaining from the disk BMS data recorded according to execution of BMS, for example, the BMS status information and BMS result entries, so that bad sectors of a disk and disk failures may be proactively detected. In a further embodiment, since BMS may be executed by a disk itself and BMS data may be recorded according to execution of BMS by a disk, data may not require to be read and checked from a disk during completion of disk scrubbing, which may significantly reduce resource consumption and time cost of the disk scrubbing, may avoid extra disk wear caused by read of the disk, and may also improve accuracy of the disk scrubbing because connection failures of I/O ports may not affect the determination of bad sectors.

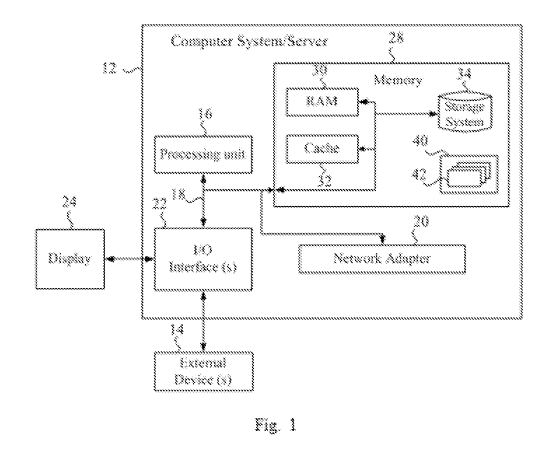

FIG. 1 illustrates a block diagram of an example computer system/server 12 suitable for implementing embodiments of the present disclosure. The computer system/server 12 shown in FIG. 1 is only an example and is not intended to suggest any limitation to the scope of use or functionality of embodiments of the disclosure.

As shown in FIG. 1, computer system/server 12 illustrates a general-purpose computing device. The components of computer system/server 12 includes, but are not limited to, one or more processors or processing units 16, system memory 28, and bus 18 that couples various system components including system memory 28 to processing unit 16. System memory 28 may include computer system readable medium in the form of volatile memory, such as random access memory 30 and/or cache 32. Each drive can be connected to bus 18 by one or more data medium interfaces. Computer system/server 12 may also communicate, as required, with one or more external devices 14 such as display 24, storage device 14, etc., one or more devices that enable a user to interact with computer system/server 12; and/or any devices (e.g., a network card, a modem, etc.) that enable computer system/server 12 to communicate with one or more other computing devices. Such communication can occur via Input/Output (I/O) interface(s) 22. Still yet, computer system/server 12 can communicate with one or more networks such as a local area network (LAN), a wide area network (WAN), and/or a public network (e.g., the Internet) via network adapter 20. As depicted, network adapter 20 communicates with the other components of computer system/server 12 via bus 18. Program/utility 40, having a set (at least one) of program modules 42, may be stored in memory 28.

In one embodiment, bus 18 may represent one or more of several types of bus structures that may include a memory bus or memory controller, a peripheral bus, an accelerated graphics port, a processor or a local bus using any of a variety of bus architectures. In an example embodiment, and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

In a further embodiment, computer system/server 12 may include a variety of computer system readable medium. In a further embodiment, such medium may be any available medium that is accessible by computer system/server, including both volatile and non-volatile medium, removable and non-removable medium.

In one embodiment, computer system/server may further include other removable/non-removable, volatile/non-volatile computer system storage medium. In a further embodiment, a disk drive for reading from and writing to a removable, non-volatile disk (e.g., a “floppy disk”), and an optical disk drive for reading from or writing to a removable, non-volatile optical disk such as a CD-ROM, DVD-ROM or other optical medium may be provided. In a further embodiment, memory 28 may include at least one program product having a set (e.g., at least one) of program modules that may be configured to carry out various functions of embodiments of the disclosure.

In one embodiment, program/utility 40, which may be having a set (at least one) of program modules 42, may be stored in memory 28 by way of example. In a further embodiment, program modules 42 may include, but may not limited to an operating system, one or more application programs, other program modules, and program data. In a further embodiment, each of the operating system, one or more application programs, other program modules, and program data or some combination thereof may include an implementation of a networking environment. In a further embodiment, program modules 42 may generally carry out the functions and/or methodologies of embodiments of the disclosure as described herein. In one embodiment, it may be understood that although not shown in the figure, other hardware and/or software components may be used in conjunction with computer system/server. An example embodiment may include, but may not limited to, microcode, device drivers, redundant processing units, external disk drive arrays, RAID systems, tape drives, data archival storage systems, etc.

In description of example embodiments, “includes” and its variants are to be read as open-ended terms that mean “includes, but is not limited to.” The term “based on” is to be read as “based at least in part on.” The term “an embodiment” and “the embodiment” are to be read as “at least one embodiment.”

Embodiments of the present disclosure will be described in details below. In certain embodiment, it may be appreciated through the description below that one of the inventive ideas of the present disclosure may be to utilize the BMS capability of a disk to implement disk scrubbing. In one embodiment, BMS data, such as BMS status information and BMS result entries, that may be recorded according to execution of BMS may be obtained from a disk to determine bad sectors of a disk and may be used to recover data stored in bad sectors, so that bad sectors of a disk and disk failures may be proactively detected. In a further embodiment, since BMS may be executed by a disk itself and BMS data may be recorded according to execution of BMS by a disk, data may not be required to be read and checked from a disk during completion of disk scrubbing, which may significantly reduce resource consumption and time cost of disk scrubbing, may avoid extra disk wear caused by read of a disk, and may improve accuracy of a disk scrubbing because connection failures of I/O ports may not affect determination of bad sectors.

In one embodiment, Background Medium Scan (BMS) may be executed by individual disks to maintain a good state of the data. In a further embodiment, BMS process may be defined as any operations that may be performed in a disk and may not require any system transmission bandwidth. In a further embodiment, during execution of BMS process, data blocks of a disk may not be read from the disk and stored in a cache of the operating system. In a further embodiment, BMS process may operate while the disk is generally idle. In an example embodiment, a disk may perform BMS when no read/write command may be received in a time period of about 500 ms.

In an example embodiment, BMS process may be as follows: data may be read by a disk internally in units of sectors, and data stored in each sector may be checked to determine whether it may be correct with smaller ECC (Error Check and Correction) tolerance. In an example embodiment, during normal reads and writes of the disk, it may be determined whether data stored in sectors may be correct with an ECC tolerance of 100 bits/sector. In a further embodiment, in a BMS process, correctness of the data may be determined with a smaller ECC tolerance, for example, 80 bits/sector. In a further embodiment, when data stored in a certain sector may be detected as incorrect, BMS process may recover this portion of data with a normal ECC tolerance, and may then attempt to rewrite the data into an original sector. In a further embodiment, BMS process may check whether the rewritten data may be re-read correctly. In a further embodiment, if the data may not be re-read, a sector may be recorded as an un-recovered sector. In a further embodiment, if data may be re-read, the sector may be recorded as a recovered sector. In a further embodiment, if data in a certain sector initially may not be read, BMS process may record this sector as an un-recovered sector. In a further embodiment, BMS process may also identify a sector as may being in need of reallocation, and when a next operation of this sector may be a write operation, data to be written may be reallocated to other sectors.

In a further embodiment, regarding specific description of BMS, reference may be made to the documents “Information technology-SCSI Primary Commands-4” and “Information technology-SCSI Block Commands-3” issued by a technical committee of T10 as an authentication standard committee INCITS (InterNational Committee for Information Technology Standards), the disclosures of which are incorporated herein in their entireties by reference.

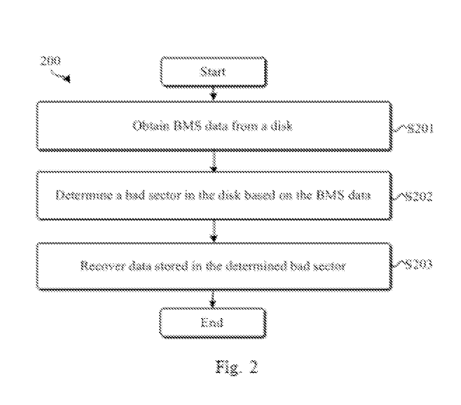

Reference is now made to FIG. 2, which illustrates a flowchart of a method for disk data management 200 according to an embodiment of the present disclosure. It should be appreciated that various steps in the method 200 may be performed in a different order, and/or performed concurrently. The method 200 may comprise additional steps and/or omit execution of some shown steps. The scope of the present disclosure is not limited in this regard.

In step S201 of the method 200, BMS data is obtained from a disk. The BMS data is recorded according to execution of BMS by the disk. In step S202, a bad sector in the disk is determined based on the BMS data. In step S203, data stored in the determined bad sector is recovered. The scrubbing of a single disk is completed through the steps S201-S203 of the above method 200. If the data storage system requiring disk scrubbing has a plurality of disks, the above method 200 may be performed simultaneously for each disk.

According to an embodiment of the present disclosure, disk scrubbing may be performed to ensure data integrity based on the BMS data of the disk. In an embodiment, before starting execution of disk scrubbing for a disk, it may first determine whether a disk supports BMS. In an example embodiment, capability of BMS may be determined via a SCSI (small computer system interface) command to check whether a disk supports BMS.

According to an embodiment, a parameter for BMS may be configured before a disk executes BMS. In a further embodiment, configurable parameter may include at least one of minimum idle time before execution of BMS and BMS interval time. In a further embodiment, BMS interval time may indicate a time interval between two times of BMS, for example, a length of time between a start time of the execution of previous BMS and a finishing time of the execution of a next BMS. In a further embodiment, BMS interval time may be configured as hours, tens of hours or days according to requirements of the disk scrubbing. In an example embodiment, a smaller BMS interval time may be configured for a disk that has a higher data integrity requirement or the operating environment of which may be relatively severe. In an alternate embodiment, a larger BMS interval time may be configured. In a further embodiment, a minimum idle time before execution of BMS may indicate, during one time of execution of BMS, a minimum idle time to be awaited after suspension of the execution of BMS and before restart of the execution of BMS, for example milliseconds, tens of milliseconds, or seconds. In a further embodiment, since a BMS process may operate when the disk may be idle, if the disk receives normal read, write or other commands during the execution of BMS, the current BMS process may be suspended. In a further embodiment, only when commands of the disk may be completed and other commands may not be received within the minimum idle time, the current BMS process may restart. In a further embodiment, BMS parameters to be configured may further include other parameters, and a magnitude of BMS interval time or minimum idle time may be configured as any of other values.

According to another embodiment, it may not be necessary to configure the above mentioned parameters before start of each BMS process or to individually configure parameters, but may directly employ default values for a disk.

In one embodiment, after individual disks execute BMS processes, BMS data (also referred to as BMS log data or BMS log page) may be generated. In a further embodiment, BMS data may be information recorded when a disk executes BMS and may include information related to the BMS process, information of recovered sectors during the BMS process, information of un-recovered sectors during the BMS process, and the like. In a further embodiment, BMS data may be recorded in the disk. In an embodiment of the present disclosure, these BMS data may be used to perform diagnosis for a disk to identify bad sectors from the disk.

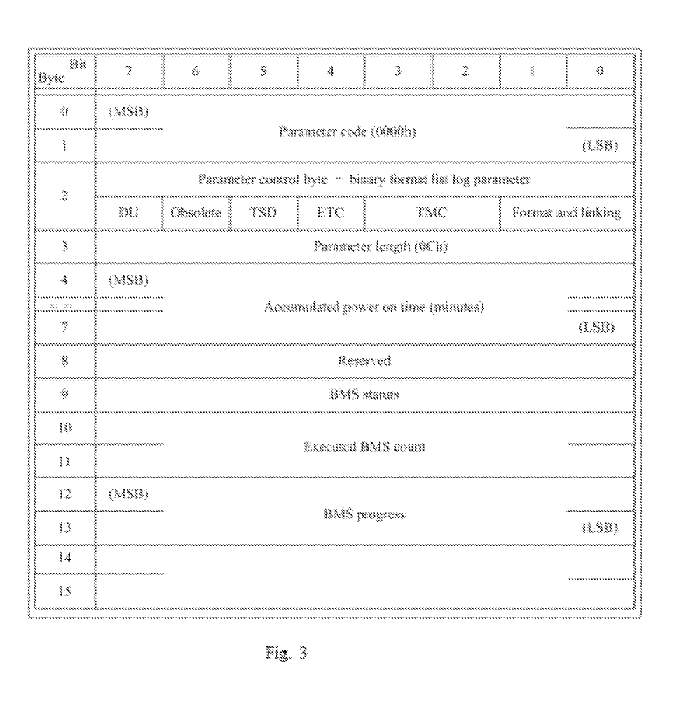

According to some embodiments, the BMS data obtained may include BMS status information and BMS result entries. In one embodiment, BMS status information may indicate a status of BMS (e.g., whether it is active), an already executed BMS count, a BMS progress (e.g., a percentage of completion of BMS), and accumulated power on time of a disk (e.g., after the last execution of BMS is completed, what may be recorded may be a completion time) and the like. In one embodiment, an example page format of BMS status information may be obtained from the disk as shown in FIG. 3. In one embodiment, BMS result entries may be associated with sectors where errors once occur or errors may be presenting as recorded by the BMS. In an embodiment, each BMS result entry may include at least an error type, time of error occurrence, a position, and a recovery statues (whether corrected via BMS process or other correction operations) of a sector.

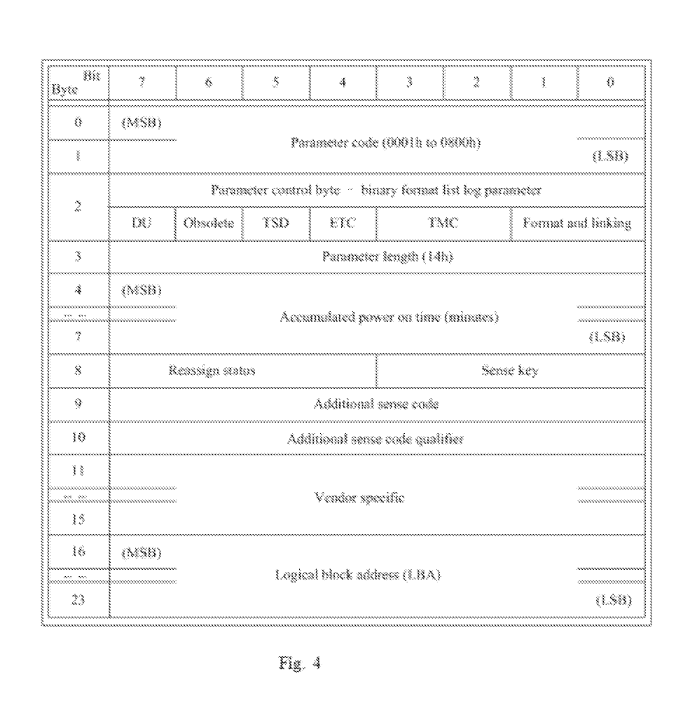

In one embodiment, an example page format of a BMS result entry may be obtained from the disk as shown in FIG. 4. In FIG. 4, the error type of a sector is indicated by a sense key and may include a recovered error and a medium error; the time of error occurrence of the sector is indicated by the accumulated power on time of the disk; the position of the sector is indicated by logical block addressing (LBA); and a reassign status indicates a recovery status of the sector, for example whether the sector is corrected.

In one embodiment, a number of BMS result entries may be one or more. In a further embodiment, in case of excellent data integrity of a disk, it may be possible that there are no BMS result entries. In a further embodiment, use of BMS data may include BMS status information and BMS result entries, and will be described in detail below. In a further embodiment, BMS status information and BMS result entries may include content other than information listed above, and other page formats of BMS status information and BMS result entries than those shown in FIGS. 3 and 4 may also be envisaged.

In one embodiment, since a disk severing as a storage device may not report initiatively whether execution of BMS may be completed, in order to obtain BMS data, BMS status information may be queried from a disk to determine whether execution of the BMS may have been completed. In an example embodiment, BMS status in BMS status information may indicate whether BMS process may be active, and BMS progress may indicate a percentage of completion of the BMS. In a further embodiment, if it may be known through a query for BMS status information that the BMS process may be active and a percentage of completion of the BMS may be less than 100 percent, then it may be determined that the current BMS process may be in progress. In a further embodiment, if it may be known through a query for BMS status information that the BMS process may be inactive and a percentage of completion of the BMS may be less than 100 percent, then it may be determined that the current BMS process may be suspended. In a further embodiment, if it may be known through a query for BMS status information that the BMS process may be inactive and a percentage of completion of the BMS may reach 100 percent, then it may be determined that the current BMS process may have been completed. In a further embodiment, BMS status information may be queried from a disk periodically or in other preset time interval manners.

In an embodiment, in case that execution of BMS may be determined to be completed, BMS data may be obtained from a disk, whereupon BMS data may include information recorded by the entire BMS process. In another embodiment, the BMS data may be obtained from a disk after a percentage of completion of the BMS may be determined to reach a predetermined threshold (e.g., 50 percent). In a further embodiment, BMS data may be obtained directly from a disk without determining whether an execution of the BMS may have been completed. In a further embodiment, BMS data may be obtained when the execution of BMS may not have been completed may only include information recorded by the executed BMS before this point of time.

In one embodiment, as described above, BMS data may include information relating to data errors, which may be detected during the execution of BMS. In a further embodiment, a bad sector in the disk may be determined based on BMS data.

In some embodiments, since a disk may have executed the BMS process for more than one time, the BMS result entries in BMS data obtained (in step S201) may include BMS result entries recorded for multiple times of BMS processes. In a further embodiment, it may be generally desirable to obtain BMS result entries recorded by the last execution of BMS, because these entries reflect latest disk conditions. In a further embodiment, it may be necessary to identify from the obtained BMS result entries BMS result entries recorded according to a last/previous execution of BMS. In one embodiment, identifying may include determining a time duration of a last execution of BMS based on BMS status information; identifying, based on a time duration of a last execution of the BMS, from the BMS result entries BMS result entries recorded according to a last execution of BMS. In a further embodiment, a bad sector in a disk may be determined based on an identified BMS result entries.

In some embodiments, BMS status information may include the accumulated power on time of a disk. In a further embodiment, a time may indicate the time when BMS status information may have been obtained, and after a last execution of the BMS may have been completed, and the time may indicate the time of completion. In a further embodiment, an accumulated power on time of a disk may be for example in units of minute, hour, or day. In a further embodiment, start time and finishing time, namely a time duration of execution, may be determined according to an accumulated power on time of a disk related to a last BMS and an accumulated power on time of a disk related to a preceding BMS. In a further embodiment, if the BMS status information may be obtained when a last execution of the BMS has not been completed, a determined time duration of execution may be a time period between completion of a preceding execution of BMS and the time when BMS status information is obtained.

In one embodiment, after a time duration of a last execution of BMS may have been determined, since each BMS result entry may include a time of error occurrence of a sector (e.g., the accumulated power on time of the disk when the error is detected), BMS result entries recorded according to a last execution of BMS may be identified in a way of determining whether the time of error occurrence of a sector included by each BMS result entry falls within the time duration of the last execution of BMS. In an example embodiment, it may be assumed that a time duration of a last execution of BMS may be determined as from 6000 minutes to 6120 minutes of power on time of a disk. In a further embodiment, if a time of error occurrence of a sector included by each BMS result entry (e.g., the accumulated power on time of FIG. 4) may be 6010 minutes, time falls within a time duration of execution from 6000 minutes to 6120 minutes, so this BMS result entry may be determined as being recorded during the last execution of BMS.

In one embodiment, BMS result entries may be recorded according to a last execution of BMS and may be identified in other ways other than those described above. In an example embodiment, a time duration of a last execution of BMS may be determined according to auxiliary information such as pre-configured BMS parameters so as to identify entries that may belong to a last execution of BMS from BMS result entries that may be generated by multiple times of execution of BMS.

According to an embodiment of the present disclosure, the bad sector in a disk may be determined based on the identified BMS result entries and may include determining a first result entry from the identified BMS result entries, the first result entry may include an error type that may indicate a medium error and a recovery status that may be indicate that the sector may not be corrected; and determining a bad sector in a disk that may be based on a position included in a first result entry.

In one embodiment, during execution of BMS, when a sector may be detected to have a data error but correct data is subsequently recovered by the BMS process using ECC, the error type of this sector may be marked by BMS as a recovered error, and the error that may not be recovered by the BMS may be marked as a medium error. In a further embodiment, in addition to the medium error and the recovered error, the error type in the BMS result entry may further indicate other error types such as a hardware error.

In one embodiment, when an error type of a result entry may indicate a medium error, it may not be required to determine a sector indicated by a result entry as a bad sector because erroneous data in the sector may be corrected in other ways than the BMS process, e.g., corrected in a way designated by a disk manufacturer. In a further embodiment, whether these sectors may have been corrected or not may be indicated by recovery statuses in BMS result entries (e.g., a reallocation status of FIG. 4). In a further embodiment, regarding those sectors that may be corrected, they may not be necessary to further recover during a present process. In a further embodiment, a BMS result entry may include a medium error as an error type and whose recovery status may be uncorrected might be classified into a first result entry. In a further embodiment, a bad sector may be determined based on a position included in an identified first result entry.

In a further embodiment, in addition to a way of determining a sector corresponding to a BMS result entry whose error type may be marked by BMS as a medium error and whose recovery status may indicate an uncorrected status in the above mentioned process as a bad sector, bad sectors may be determined according to other information in BMS result entries. In an embodiment, a bad sector may be determined according to only the recovery status in a BMS result entry. In an example embodiment, a sector corresponding to a BMS result entry whose recovery status may be a corrected status may be determined as a bad sector. In another embodiment, a bad sector may be determined according to only an error type in a BMS result entry. In an example embodiment, a sector corresponding to a BMS result entry whose error type may be marked by BMS as a recovered error may be determined as a bad sector. In a further embodiment, since errors once occurred in these sectors, although errors may have been recovered by BMS process or other channels, these sectors may be expected to be further recovered by using for example RAID redundancy. As another example embodiment, a sector corresponding to a BMS result entry whose error type may be marked by BMS as both a corrected error and a medium error may be determined as a bad sector.

According to an embodiment of the present disclosure, an indication associated with the determined bad sectors may be generated to notify the data storage system or an administrator of the system the number of bad sectors in the disk, positions of bad sectors and the like. In as further embodiment, data in a bad sector may be recovered by using many data recovering methods. In an embodiment, in case a disk may belong to a RAID (Redundant Array of Independent Disks), data stored in the determined bad sector may be recovered and the determined bad sector may be relocated in another available sector of the disk according to RAID redundancy so as to achieve recovery of data in the bad sector.

According to a further embodiment of the present disclosure, if a number of bad sectors may be greater than a predetermine threshold, an indication related to a disk may be generated. In a further embodiment, since too many bad sectors may indicate that there may be serious problems with a disk, with an indication that may be generated, the RAID or upper-level software, or an administrator of the data storage system may decide whether the disk should be replaced based on the indication. In an example embodiment, data on a disk may be relocated to other disks according to RAID redundancy.

In one embodiment of method 200, data may not necessarily be read from a disk and a stored data may not be analyzed necessarily; instead, BMS data recorded by BMS process of a disk itself may directly be utilized for disk scrubbing, which only may occupy very few system resources and cost little time for disk scrubbing, and may not additionally cause unnecessary wear of the disk. In a further embodiment, since disk scrubbing may not be performed by reading data from a disk, connection issues of I/O ports may not affect disk scrubbing results. In a further embodiment, besides for a data storage system that may have a plurality of disks, disk scrubbing may be performed simultaneously for the plurality of disks, and disk scrubbing efficiency may be significantly improved.

In one embodiment, as compared with the method of implementing disk scrubbing by analyzing BMS data, conventional methods of implementing disk scrubbing by reading data from a disk may be subjected to more kinds of check (e.g., CRC (Cyclic Redundancy Check) at the RAID level), but these defects may be remedied by using other disk techniques in a disk scrubbing method of the present disclosure (e.g., using a disk having a CRC capability).

In one embodiment, by analyzing BMS data, data in a bad sector may be recovered, and other aspects of a disk may be diagnosed. In a further embodiment, as BMS is executed by a disk itself, multiple times of BMS may have been executed since the disk is powered on for the first time. In a further embodiment, BMS conditions may be analyzed further by using BMS data recorded by these BMSs. In some embodiments of the present disclosure, an indication related to a health condition of a disk may be generated based on BMS result entries recorded based on at least one execution of BMS. In such embodiments, all of the BMSs executed since a disk may be powered on for the first time, or a predetermined number of BMSs counted from last BMS may be considered; or a predetermined number of BMSs may be arbitrarily selected from all of the BMSs that may have been executed.

In one embodiment, since BMS status information corresponding to each execution of BMS records, for example, the already executed BMS count and the accumulated power on time of the disk, it may be feasible to identify one or more times of BMS from the executed BMSs according to BMS status information, and BMS result entries recorded according to the identified BMSs may be determined In an example embodiment, after completion of the last execution of BMS, the disk may have executed a total of 10 times of BMS. In a further embodiment, if it may be desired to consider BMS result entries recorded according to the last three times of execution of BMS, those BMS status information in which the already executed BMS counts are recorded as 10, 9, and 8 respectively may be determined based on “the already executed BMS count” recorded in BMS status information corresponding to the executed BMSs. In a further embodiment, time durations of execution of the last three times of BMSs may be determined according to a magnitude of the accumulated power on time of a disk in the BMS status information. In a further embodiment, BMS result entries recorded according to the three times of execution of the BMS may be identified from all BMS result entries of a disk according to a time duration of each execution of the BMS.

In an example embodiment, statistics of result entries indicating error types as the recovered errors may be made among the BMS result entries. In a further embodiment, when there are a lot of sectors with recovered errors, it may mean that errors might have easily occurred in the disk and this disk may have an undesirable health condition, so a corresponding indication may be generated to enable the RAID or upper-level software or an administrator of the data storage system to decide whether the disk may be replaced based thereon. In a further embodiment, similarly, statistics of result entries whose error types may be medium errors and whose recovery statuses might have been corrected may be made. In a further embodiment, statistics data indicate that the number of sectors that have medium errors (i.e., an error that cannot be recovered during the BMS process) might have occurred therein and may have been recovered by other channels. In a further embodiment, if the number is greater, a corresponding indication may be generated to facilitate replacement of the disk.

In another example embodiment, statistics may be made according to the BMS result entries for the number of recovered errors or medium errors occurring in a certain sector (the corresponding recovery statuses are corrected or uncorrected). In a further embodiment, if errors occur frequently on a certain sector, the health condition of the sector may still be indicated as undesirable even though the errors on the sector may be recovered during the BMS process or in other ways. In a further embodiment, when a number from the statistics may be greater than a predetermined threshold, an indication may be generated to enable the RAID or upper-level software or an administrator to decide the disposal for the sector or the disk. In an alternate embodiment, a sector may be directly relocated to another available sector of the disk.

In an embodiment of the present disclosure, a BMS result entry may further include information of a head or cylinder of a sector with a recovered error or a medium error (the corresponding recovery status is corrected or not corrected). In a further example embodiment, statistics may be made for a number of a certain head or cylinder being recorded in the BMS result entries based on the BMS result entries recorded according to at least one execution of the BMS. In a further embodiment, if the number from the statistics may be greater, it may mean that a head or a cylinder may be the reason that might be causing occurrence of the errors in the sector. In a further embodiment, a head or a cylinder may be marked as a bad head or bad cylinder and a corresponding indication may be generated to enable the RAID or upper-level software or an administrator to decide whether the head or the cylinder should be corrected, and whether the disk may be further used or may be replaced.

In some example embodiments of generating an indication related to the health condition of a disk based on BMS result entries recorded according to at least one execution of the BMS are illustrated above. It should be appreciated that more indications related to the disk may be determined according to actual requirements by using the BMS result entries and/or BMS status information.

The spirit and principle of the present invention have been illustrated above in conjunction with several specific implementations. According to an embodiment of the present disclosure, BMS capability of a disk may be utilized to implement disk scrubbing. In a further embodiment, a bad sector of the disk may be determined and data stored in the bad sector may be recovered by obtaining from the disk the BMS data recorded according to execution of the BMS, for example, BMS status information and BMS result entries, so that bad sectors of the disk and disk failures may be proactively detected. In a further embodiment, since BMS may be executed by the disk itself and BMS data may be recorded according to execution of the BMS by the disk, data may not be required to be read and checked from the disk during completion of disk scrubbing, which may significantly reduce resource consumption and time cost of the disk scrubbing, may avoid extra disk wear caused by read of the disk, and may improve accuracy of the disk scrubbing because connection failures of I/O ports may not affect the determination of bad sectors.

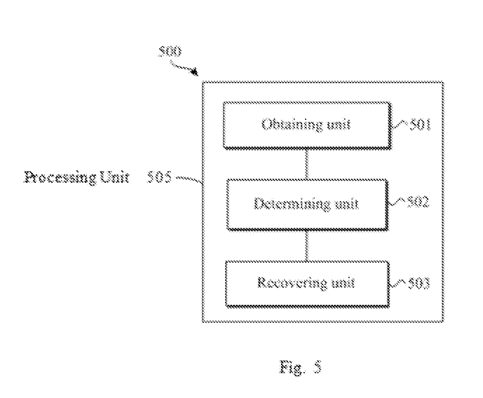

FIG. 5 illustrates a block diagram of an apparatus 500 for disk data management according to one embodiment of the present invention. As shown in FIG. 5, the apparatus 500 comprises obtaining unit 501 configured to obtain BMS data from a disk. The apparatus further comprises determining unit 502 configured to determine a bad sector in the disk based on the BMS data; and recovering unit 503 configured to recover data stored in the determined bad sector. Alternatively, processing unit 505 may replace obtaining unit 501, determining unit 502 and receiving unit 503 and processing unit 505 may be configured to perform the tasks and functions of each of these units.

According to an embodiment, BMS data may be recorded according to execution of BMS by the disk.

According to an embodiment, apparatus 500 further comprises a configuring unit that may be configured to configure, before the disk executes the BMS, a parameter for the BMS. In a further embodiment, a parameter includes at least one of minimum idle time before the execution of the BMS and BMS interval time. In one embodiment processing unit 505 may also perform the tasks and functions of the configuring unit.

According to an embodiment, BMS data may include BMS status information and BMS result entries. In a further embodiment, determining unit 502 may include an execution time determining unit that may be configured to determine a time duration of last execution of the BMS based on the BMS status information. In a further embodiment determining unit 502 may include a result entry identifying unit that may be configured to identify, based on the time duration of the last execution of the BMS, from the BMS result entries BMS result entries recorded according to the last execution of the BMS. The determining unit 502 is configured to determine the bad sector in the disk according to the identified BMS result entries. In one embodiment processing unit 505 may also perform the tasks and functions of the execution time determining unit and a result entry identifying unit.

According to an embodiment, each BMS result entry may include at least an error type, time of error occurrence, a position, and a recovery status of a sector, the error type including at least a recovered error and a medium error. In a further embodiment, determining unit 502 may be further configured to determine a first result entry from the identified BMS result entries, the first result entry may include an error type that may indicate a medium error and a recovery status that may indicate that the sector may not have been corrected; and may determine a bad sector in the disk based on a position included in the first result entry.

According to an embodiment, apparatus 500 further comprises a query unit that may be configured to query for BMS status information from the disk, before obtaining the BMS data, to determine whether the execution of the BMS may have been completed. In one embodiment processing unit 505 may also perform the tasks and functions of the query unit.

According to an embodiment, recovering unit 503 may be further configured to recover data stored in the determined bad sector and may be configured to relocate the determined bad sector in another available sector of the disk based on RAID redundancy.

According to an embodiment, apparatus 500 may further include an indication generating unit that may be configured to generate an indication related to a health condition of the disk based on BMS result entries recorded according to at least one execution of the BMS. In one embodiment processing unit 505 may also perform the tasks and functions of the indication generating unit.

It should be appreciated that for the sake of clarity, FIG. 5 does not show optional units or subunits included by apparatus 500. All features and operations described above are adapted for apparatus 500. Furthermore, division of units or subunits in apparatus 500 may not be restrictive, but are exemplary in nature, and intended to describe their main functions or operations in logical sense. A function of a unit may be implemented by a plurality of units; on the contrary, a plurality of units can also be implemented by one unit.

Furthermore, the units included by apparatus 500 may be implemented in various manners, including software, hardware, firmware, and any combination thereof. For example, in some embodiments, apparatus 500 may be implemented by software and/or hardware. Alternatively or additionally, apparatus 500 may be implemented partially or completely based on hardware. For example, one or more units in apparatus 500 may be implemented as integrated circuit (IC) chip, Application Specific Integrated Circuit (ASIC), System on Chip (SOC), Field Programmable Gate Array (FPGA) and the like.

The present disclosure may be a system, a method, and/or a computer program product. The computer program product may include a computer readable storage medium having computer readable program instructions thereon for causing a processor to carry out various aspects of the present invention.

In one embodiment a computer readable storage medium may be a tangible device that can retain and store instructions for use by an indication execution device. In a further embodiment, a computer readable storage medium may be, for example, but is not limited to, an electronic storage device, a magnetic storage device, an optical storage device, an electromagnetic storage device, a semiconductor storage device, or any suitable combination of the foregoing. In a further embodiment, a non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In a further embodiment a computer readable storage medium, as used herein, may not to be construed as being transitory signals per se, such as radio waves or other freely propagating electromagnetic waves, electromagnetic waves propagating through a waveguide or other transmission medium (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. In some embodiments, a network may comprise copper transmission cables, optical transmission fibers, wireless transmission, routers, firewalls, switches, gateway computers and/or edge servers. In some other embodiments, a network adapter card or network interface in each computing/processing device receives computer readable program instructions from the network and forwards the computer readable program instructions for storage in a computer readable storage medium within the respective computing/processing device.

Computer readable program instructions for carrying out executions of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which executed via the processor of the computer or other programmable data processing apparatus, create means for implementing the functions/actions specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/actions specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/actions specified in the flowchart and/or block diagram block or blocks.

The flowchart and block diagrams in the Figures illustrate the architecture, functionality, and operations of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many corrections and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for disk data management, comprising:
obtaining background medium scan (BMS) data from a disk;
determining a bad sector in the disk based on the BMS data; and
recovering data stored in the determined bad sector.

2. The method according to claim 1, wherein the BMS data is recorded according to execution of BMS by the disk.

3. The method according to claim 2, further comprising:
configuring, before the disk executes the BMS, a parameter for the BMS, wherein the parameter includes at least one of minimum idle time before the execution of the BMS by the disk and a BMS interval time.

4. The method according to claim 2, wherein the BMS data includes a BMS status information and BMS result entries, and wherein determining a bad sector in the disk based on the BMS data further comprises:
determining a time duration of a last execution of the BMS based on the BMS status information;
identifying, based on the time duration of the last execution of the BMS, BMS result entries recorded according to the last execution of the BMS from the BMS result entries; and
determining the bad sector in the disk based on the identified BMS result entries.

5. The method according to claim 4, wherein each of the BMS result entries includes at least one from the group consisting of: an error type, time of error occurrence, a position, and a recovery status of a sector, wherein the error type including at least a recovered error and a medium error; and wherein determining the bad sector in the disk based on the identified BMS result entries further comprises:
determining a first result entry from the identified BMS result entries, the first result entry including an error type indicating a medium error and a recovery status indicating that the sector is not corrected; and
determining the bad sector in the disk based on a position included in the first result entry.

6. The method according to claim 4, further comprising:
querying for the BMS status information from the disk, before obtaining the BMS data, to determine whether the execution of the BMS is completed on the disk.

7. The method according to claim 1, wherein recovering data stored in the bad sector comprises:
recovering the data stored in the bad sector determined and relocating the bad sector determined to another available sector of the disk based on redundant array of independent disks (RAID) redundancy.

8. The method according to claim 7, further comprising:
generating an indication related to a health condition of the disk based on the BMS result entries according to at least one execution of the BMS.

9. A system, comprising:
a data storage system including a disk: and
computer-executable logic operating in memory, wherein the computer-executable program logic is configured to manage disk data, wherein the computer-executable program logic is configured for the execution of:
obtaining background medium scan (BMS) data from a disk;
determining a bad sector in the disk based on the BMS data; and
recovering data stored in the determined bad sector.

10. The system of claim 9, wherein the BMS data is recorded according to execution of BMS by the disk.

11. The system of claim 10, wherein the computer-executable program logic is further configured for the execution of:
configuring, before the disk executes the BMS, a parameter for the BMS, wherein the parameter includes at least one of minimum idle time before the execution of the BMS by the disk and a BMS interval time.

12. The system of claim 9, wherein the BMS data includes a BMS status information and BMS result entries, and wherein determining a bad sector in the disk based on the BMS data further comprises:
determining a time duration of a last execution of the BMS based on the BMS status information;
identifying, based on the time duration of the last execution of the BMS, BMS result entries recorded according to the last execution of the BMS from the BMS result entries; and
determining the bad sector in the disk based on the identified BMS result entries.

13. The system of claim 12, wherein each of the BMS result entries includes at least one from the group consisting of: an error type, time of error occurrence, a position, and a recovery status of a sector, wherein the error type including at least a recovered error and a medium error; and wherein determining the bad sector in the disk based on the identified BMS result entries further comprises:
determining a first result entry from the identified BMS result entries, the first result entry including an error type indicating a medium error and a recovery status indicating that the sector is not corrected; and
determining the bad sector in the disk based on a position included in the first result entry.

14. The system of claim 12, wherein the computer-executable program logic is further configured for the execution of:
querying for the BMS status information from the disk, before obtaining the BMS data, to determine whether the execution of the BMS is completed on the disk.

15. The system of claim 9, wherein recovering data stored in the bad sector comprises:
recovering the data stored in the bad sector determined and relocating the bad sector determined to another available sector of the disk based on redundant array of independent disks (RAID) redundancy.

16. The system of claim 15, wherein the computer-executable program logic is further configured for the execution of:
generating an indication related to a health condition of the disk based on the BMS result entries according to at least one execution of the BMS.

17. A computer program product for managing disk data, the computer program product comprising:
a non-transitory computer readable medium encoded with computer executable program code, wherein the code enables execution across one or more processors:
obtaining background medium scan (BMS) data from a disk, wherein the BMS data is recorded according to execution of BMS by the disk; wherein the BMS data includes a BMS status information and BMS result entries, and wherein determining a bad sector in the disk based on the BMS data further comprises:
determining a time duration of a last execution of the BMS based on the BMS status information;
identifying, based on the time duration of the last execution of the BMS, BMS result entries recorded according to the last execution of the BMS from the BMS result entries; and
determining the bad sector in the disk based on the identified BMS result entries;
determining a bad sector in the disk based on the BMS data;
recovering data stored in the determined bad sector; and
recovering the data stored in the bad sector determined and relocating the bad sector determined to another available sector of the disk based on redundant array of independent disks (RAID) redundancy.

18. The computer program product according to claim 17, wherein the code further enables execution of:
configuring, before the disk executes the BMS, a parameter for the BMS, wherein the parameter includes at least one of minimum idle time before the execution of the BMS by the disk and a BMS interval time; and
querying for the BMS status information from the disk, before obtaining the BMS data, to determine whether the execution of the BMS is completed on the disk.

19. The computer program product according to claim 17, wherein each of the BMS result entries includes at least one from the group consisting of: an error type, time of error occurrence, a position, and a recovery status of a sector, wherein the error type including at least a recovered error and a medium error; and wherein determining the bad sector in the disk based on the identified BMS result entries further comprises:
determining a first result entry from the identified BMS result entries, the first result entry including an error type indicating a medium error and a recovery status indicating that the sector is not corrected; and
determining the bad sector in the disk based on a position included in the first result entry.

20. The computer program product according to claim 17, wherein the code further enables execution of:
generating an indication related to a health condition of the disk based on the BMS result entries according to at least one execution of the BMS.
